(19) United States
(12) Patent Application Publication
(10) Pub. No.: US 2007/0130076 A1
(43) Pub. Date: Jun. 7, 2007

(54) Method of providing DRM interoperability and ad hoc network device using the same

(75) Inventors: Sang-Do Park, Seoul (KR); Moon-Jeong Choi, Seoul (KR); Jun-Hyeong Kim, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/433,432

(22) Filed: May 15, 2006

(30) Foreign Application Priority Data
Dec. 2, 2005 (KR) 2005-0117127

(51) Int. Cl. G06Q 99/00

(52) U.S. Cl. 705/57

(57) ABSTRACT

A method of providing digital rights management (DRM) interoperability and an ad hoc network device are provided where. a sink device requests a source device to transmit a receivable content in an ad hoc network, the source device provides DRM information corresponding to the requested receivable content, the sink device determines whether downloading of a DRM module is necessary using the DRM information, and the DRM module is downloaded as necessary, from the source device, to bind the DRM module to the requested receivable content. Accordingly, contents with different applied DRM technologies may be effectively shared in an ad hoc network.

### CROSS-REFERENCE TO RELATED APPLICATIONS

This application claims the benefit under 35 U.S.C. §119(a) of a Korean Patent Application Ser. No. 10-2005-117127, filed on Dec. 2, 2005, in the Korean Intellectual Property Office, the entire contents of which is hereby incorporated by reference.

### BACKGROUND OF THE INVENTION

1. Field of the Invention

The present invention relates to digital rights management (DRM). More particularly, the present invention relates to a method of providing DRM interoperability and an ad hoc network device using the method.

2. Description of Related Art

The current popularity of digital content distribution has led to the active development of a variety of technologies for creating reliable distribution environments. In these environments, illegal copying may be prevented and concerned parties may legally utilize contents and gain benefits. DDRM is in the spotlight for its effect on technology. DRM facilitates reliable license, compliance with a copyright and authentication, and reliable environment and infrastructure, as a protection, management and distribution system with respect to digital contents. Also, DRM comprises hardware and software for procedures, processes and programs to manage copyrights.

DRM widely utilizes a security technology to prevent illegal distribution of contents. The security technology protects rights of a content owner and also facilitates easy and legal acquisition of digital contents by a consumer. DRM protects contents which are transmitted between network devices when one system interoperates with another system. A network device that has a designated security program may receive and utilize contents.

DRM can be implemented using a variety of methods. For example, DRM called A may be utilized in a Window media player of a computer and DRM called B may be utilized in a mobile MP3 player. In this case, contents may not be exchanged and utilized between the computer utilizing the DRM A and the MP3 player utilizing the DRM B.

An ad hoc network is a communication network which comprises a mobile host, which does not have a fixed wired network. The ad hoc network is suitable for use when it is difficult to construct a wired network or when a wired network is utilized for a short period after its construction. Also, the ad hoc network does not limit movement of a host and does not require a wired network and a base station. Accordingly, a network may be quickly constructed at a reduced cost.

In an ad hoc network, each node operates as one router and not as a host. Also, each node may have multiple paths with respect to other nodes and the path may be dynamically established.

An ad hoc network as described above may be effectively utilized in an emergency situation or an environment where a continuous network connection is not required. However, a method of providing DRM interoperability which can effectively share contents in the ad hoc network has never been proposed.

Accordingly, a new method of providing DRM interoperability and an ad hoc network device using the method are desired for peer to peer (P2P) connection via an ad hoc network so that a user can effectively download and update DRM associated with desired contents from a peer.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method for providing digital rights management (DRM) interoperability and an ad hoc network device which can receive a DRM module from a peer in an ad hoc network and effectively share contents with different applied DRM technologies.

Exemplary embodiments of the present invention also provide a method for providing DRM interoperability and an ad hoc network device which facilitate sharing of content, within a limit of the content's right, when, for example, a connection from a service provider is disconnected.

Exemplary embodiments of the present invention also provide a method for providing DRM interoperability and an ad hoc network device which facilitate sharing of contents with new applied DRM technologies by existing devices, and facilitates forward compatibility.

Exemplary embodiments of the present invention also provide a method for providing DRM interoperability and an ad hoc network device in which a network device automatically downloads a DRM module from a content source and applies the downloaded DRM to a corresponding content, thereby, for example, reducing a need for user manipulation and improving user convenience.

Exemplary embodiments of the present invention also provides a DRM interoperability method and an ad hoc network device which facilitate DRM interoperability when DRM, for example, technology applied to a content is updated.

An exemplary embodiment of the present invention also provide a method for providing DRM interoperability and an ad hoc network device which facilitate DRM interoperability even in a different type of platform.

Exemplary embodiments of the present invention also provide a method for providing DRM interoperability and an ad hoc network device suitable for interoperability in an ad hoc network using a DRM technology such as a plug-in method.

According to an aspect of an exemplary embodiment of the present invention, a method for providing DRM interoperability comprises sending a request to a source device from, for example, a sink device to transmit a receivable content in an ad hoc network, providing from the source device DRM information corresponding to the requested receivable content, the sink device determining whether downloading of a DRM module is necessary using the DRM information, and downloading the DRM module from the source device, as necessary, to bind the DRM module to the requested receivable content.

According to another aspect of an exemplary embodiment of the present invention, the method for providing DRM interoperability further comprises the source device providing parser information on the DRM information, the sink device determining whether downloading of a parser module for parsing the DRM information is necessary using the parser information, and downloading the parser module, as necessary, from the source device.

According to still another aspect of an exemplary embodiment of the present invention, the method for providing DRM interoperability further comprises the source device checking whether the requested receivable content is distributable. When the requested receivable content is distributable, a right with respect to the content is updated and the DRM information is provided to the sink device.

According to yet another aspect of an exemplary embodiment of the present invention, there is provided an ad hoc network device comprising a DRM controller management unit which receives DRM information corresponding to a receivable content from a device in an ad hoc network and determines whether downloading of a DRM module is necessary by using the DRM information a DRM module transmitting/receiving unit which downloads, as necessary, the DRM module from the device, and a DRM controller which binds the DRM module to the receivable content.

According to a further aspect of an exemplary embodiment of the present invention, the ad hoc network device further comprises a right management unit. The right management unit checks and manages a right of a transferable content, in response to a request for transmission of the transferable content. DRM module transmitting/receiving unit transmits the DRM module corresponding to the transferable content, to a device requesting the transmission of the transferable content.

In an exemplary implementation of the present invention, the DRM module or the parser module may be transmitted or received as a mobile code.

Also, an exemplary embodiment of the present invention may be efficiently applicable to DRM capable of independent plug-in to a platform or a rendering player.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a diagram illustrating a method for providing DRM interoperability according to an exemplary embodiment of the present invention;

FIG. 2 is a flowchart illustrating a method for providing DRM interoperability according to an exemplary embodiment of the present invention;

FIG. 3 is a flowchart illustrating operations which may be performed between the providing of DRM information and determining of whether the downloading of a DRM module is necessary, according to an exemplary embodiment of the present invention as illustrated in FIG. 2;

FIG. 4 is a diagram illustrating an example of a data structure for transmitting/receiving DRM information and content according to an exemplary embodiment of the present invention;

FIG. 5 is a block diagram illustrating an ad hoc network device according to an exemplary embodiment of the present invention; and

FIG. 6 is a diagram illustrating operations of ad hoc network devices sharing music content according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

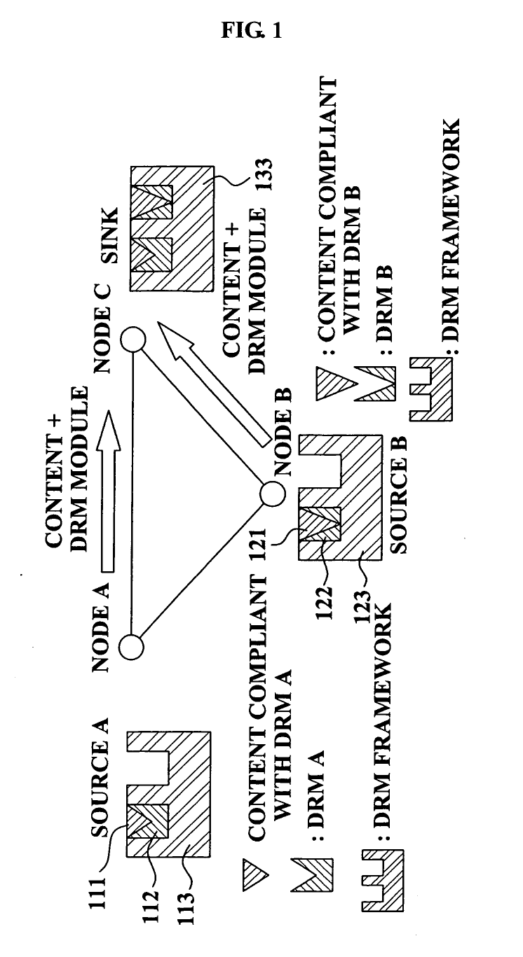

FIG. 1 is a diagram illustrating a method for providing DRM interoperability according to an exemplary embodiment of the present invention.

Referring to FIG. 1, frameworks 113, 123 and 133 are installed in three nodes A, B and C, in an ad hoc network. A downloadable digital rights management (DRM) module is executed in the frameworks 113, 123 and 133.

In an example of FIG. 1, the nodes A and B are content sources and the node C is a content sink. Namely, the node C receives content from the nodes A and B.

The three nodes A, B, and C illustrated in FIG. 1 may correspond to each ad hoc network device. For example, the node A may be a personal digital assistant (PDA), the node B an MP3 player, and the node C a mobile phone.

A DRM 112 is installed in the framework 113 of the node A. A content 111 managed by the DRM 112 is provided to the framework 113 of the node A. For example, the content 111 may be an MP3 file or a video clip.

Also, a DRM 122 is installed in the framework 123 of the node B. A content 121 managed by the DRM 122 is provided to the framework 123 of the node B.

In an exemplary implementation, the DRM 112 and the DRM 122 may be different types.

The DRM 112 or the DRM 122 may not be initially installed in the framework 133 of the node C. In this case, when it is desired for the node C to download and play the contents 111 and 121 of the nodes A and B, the node C may not play the contents 111 and 121. Due to the lack of suitable DRM in the node C for the contents 111 and 121, although the node C receives the same from the nodes A and B.

According to an exemplary embodiment of the present invention, the method for providing DRM interoperability downloads, as necessary, a DRM module corresponding to the DRMs 112 and 122 with the contents 111 and 121, and installs the downloaded DRM module in the framework 133 of the node C. For example, when playing the content 111 of the node A, the node C downloads a DRM module corresponding to the DRM 112 of the node A, from the node A, with the content 111 thereof. Also, when playing the content 121 of the node B, the node C downloads a DRM module corresponding to the DRM 122 of the node B, from the node B, with the content 121 thereof.

In an exemplary implementation, the DRM module may be downloaded as a mobile code.

A mobile code is an executable code, such as a java applet or a script, located in a remote place. The mobile code may be executed via a web browser without regard to a platform. For example, in the case of a mobile code such as a java applet, an identical code may be executed in any platform without regard to an operating system or hardware. When transmitting or receiving a DRM module as a mobile code, the DRM module may be effectively bound to a content which a user desires to play, without regard to the platform of ad hoc network devices.

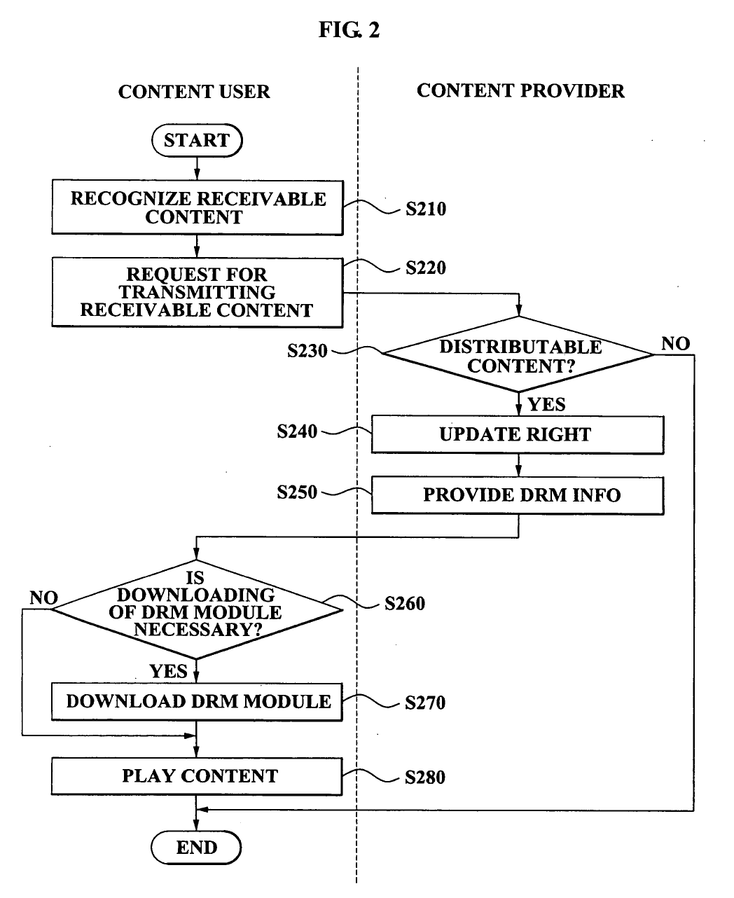

FIG. 2 is a flowchart illustrating a method for providing DRM interoperability according to an exemplary embodiment of the present invention.

Referring to FIG. 2, in the method for providing DRM interoperability according to an exemplary embodiment of the present invention, in operation S210 of FIG. 2, a sink device recognizes a receivable content of a source device through a discovery process between the source device and the sink device. In an exemplary implementation, the source device is a content provider and the sink device is a content user. The discovery process may be performed by a general method which is performed in a bootstrap processing unit of a network device.

In operation S220, the sink device requests the source device to transmit the receivable content in an ad hoc network.

For example, when a PDA user shares MP3 files stored in an MP3 player, activates a PDA player and selects one MP3 file from a list of receivable MP3 files which are displayed in the PDA player, the PDA player requests the MP3 player to transmit the selected MP3 file.

In operation S230, the source device receives the transmission request, checks a right with respect to the requested content and determines whether the requested receivable content is distributable.

When the requested receivable content is not distributable, the source device transmits a rejection message for transmission of the content to the sink device.

When the requested receivable content is distributable, a right with respect to the content is updated in operation S240. For example, a right object of the content is updated when the content is redistributable.

In operation S250, the source device provides DRM information corresponding to the requested receivable content to the sink device.

In an exemplary implementation, the DRM information may be in the form of metadata. The DRM information may also be property information of a DRM technology.

In operation S260, the sink device determines whether downloading of a DRM module is necessary, using the DRM information.

For example, when the DRM information is provided, the sink device determines whether a DRM technology applied to the requested receivable content is identical to a DRM technology maintained by the sink device. When the applied DRM technology is not identical, the sink device determines that a DRM module is necessary for performing DRM processing with respect to the requested receivable content. The DRM processing may bind the DRM module to the requested receivable content.

When the sink device maintains a DRM technology for binding a DRM module to the requested receivable content, it may not be necessary to download the DRM module. Accordingly, in operation S280, the sink device downloads the requested receivable content from the source device and plays the content.

The DRM module may be transmitted as a mobile code. Also, the DRM module may comprise at least one of a decryption module, an authentication module, a network protocol module, a license management module and a binding module.

When downloading of the DRM module is necessary, the sink device downloads the DRM module from the source device and binds the DRM module to the requested receivable content, in operation S270. Also, in operation S280, the sink device downloads the requested receivable content from the source device and plays the content.

In an exemplary implementation, DRM process may comprise all operations for binding the downloaded DRM module and applying a new DRM technology to the requested receivable content.

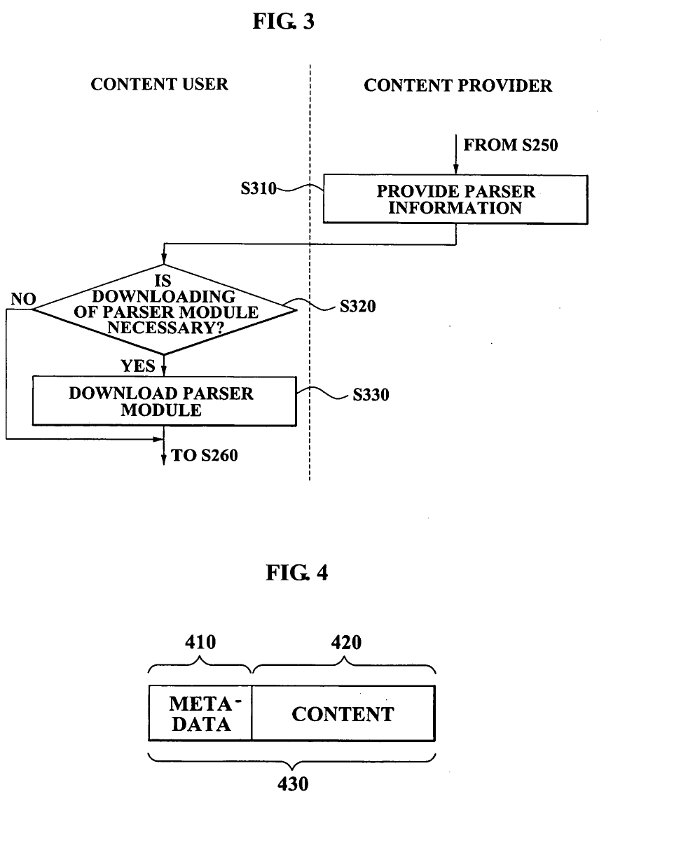

FIG. 3 is a flowchart illustrating operations which may be performed between operations S250 and S260 illustrated in FIG. 2.

Referring to FIG. 3, according to certain exemplary embodiments of the present invention, in the method of providing DRM interoperability, a source device may provide DRM information and parser information in operation S310. In an exemplary implementation, the parser information is information on a parser utilized for parsing the DRM information. A situation may occur in which the sink device cannot interpret DRM information so that the sink device cannot determine whether a DRM module is necessary. Accordingly, operation S310 facilitates the downloading of a parser module by transmitting parser information necessary for interpreting DRM information.

In operation S320, the sink device receives the parser information and determines whether downloading of a parser module required for parsing the DRM information is necessary using the parser information.

For example, when a parser for parsing the received DRM module from the source device is not provided in the sink device, the sink device may determine a parser module necessary for parsing the received DRM module by using parser information.

In operation S330, when the parser module is necessary, the sink device downloads the parser module from the source device.

In an exemplary implementation, the parser module may be downloaded as a mobile code. The sink device executes the parser module in the form of a mobile code to generate a parser, and parses the DRM information by using the parser. In this manner, the sink device may obtain information necessary for determining whether downloading of the DRM module is necessary.

For example, the DRM information may be metadata in the form of Extensible Markup Language (XML). Also, the parser module downloaded from the source device to parse the DRM information in the form of XML may be any one between a schema and a document type definition (DTD).

FIG. 4 is a diagram illustrating an example of a data structure for transmitting or receiving DRM information and content according to an exemplary embodiment of the present invention.

Referring to FIG. 4, according to an exemplary embodiment of the present invention, DRM information and content is transmitted or received via a secure container 430.

The secure container 430 comprises a metadata unit 410 for DRM information and a content unit 420 for content. In an exemplary implementation, the metadata unit 410 corresponds to a header of the secure container 430.

In an exemplary embodiment of the present invention, a source device may comprise DRM information in the metadata unit 410 of the secure container 430 illustrated in FIG. 4. The source device may also comprise content in the content unit 420, and transmit the secure container 430 to a sink device. The source device may also transmit parser information to the sink device. The parser information may also be transmitted to the secure container 430.

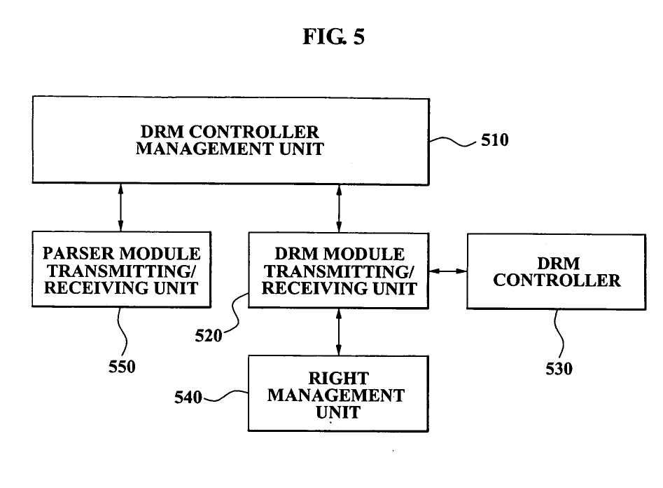

FIG. 5 is a block diagram illustrating an ad hoc network device according to an exemplary embodiment of the present invention.

Referring to FIG. 5, the ad hoc network device according to an exemplary embodiment of the present invention comprises a DRM controller management unit 510, a DRM module transmitting/receiving unit 520, a DRM controller 530, a right management unit 540 and a parser module transmitting/receiving unit 550.

The DRM controller management unit 510 receives DRM information corresponding to a receivable content from a device in an ad hoc network and determines whether to download a DRM module by using the DRM information.

For example, the DRM information may be metadata in the form of XML.

The DRM module transmitting/receiving unit 520 downloads, as necessary, the DRM module from the device in the ad hoc network.

In an exemplary implementation, the DRM module transmitting/receiving unit 520 may transmit/receive the DRM module as a mobile code.

The DRM controller 530 performs a DRM process with respect to the requested receivable content by using the received DRM module. In an exemplary implementation, the DRM process may comprise all operations for binding the downloaded DRM module and applying a new DRM technology to the requested receivable content.

The DRM controller management unit 510 receives parser information corresponding to the DRM information from the device in the ad hoc network and determines whether to download a parser module required for parsing DRM information using the parser information.

In an exemplary implementation, the parser module transmitting/receiving unit 550 downloads, as necessary, the parser module from the device.

When the parser module is downloaded from the device, the DRM controller management unit 510 generates a parser by executing the downloaded parser module, and parses DRM information by using the generated parser, to determine whether downloading of the DRM module is necessary.

In an exemplary implementation, the parser module may be downloaded as a mobile code.

The right management unit 540 checks and manages a right with respect to a transferable content, in response to a request for transmitting the transferable content to a device in another ad hoc network. For example, in response to a request for transmitting a content, the right management unit 540 may determine whether the requested content is distributable. When the requested content is not distributable, the right management unit 540 may transmit a rejection message for transmission of the content to a device in an ad hoc network which has requested the content. When the requested content is distributable, the right management unit 540 may update a right object with respect to a corresponding content and make a source node and a service provider abide by an initially contracted right of content use. Also, the right management unit 540 may make the DRM module transmitting/receiving unit 520 provide DRM information to a device which has requested a content.

According to exemplary embodiments of the present invention, an ad hoc network device may further comprise a bootstrap processing unit, a network interface and a rendering player. The bootstrap processing unit performs a discovery operation between ad hoc network nodes. The network interface performs network interfacing.

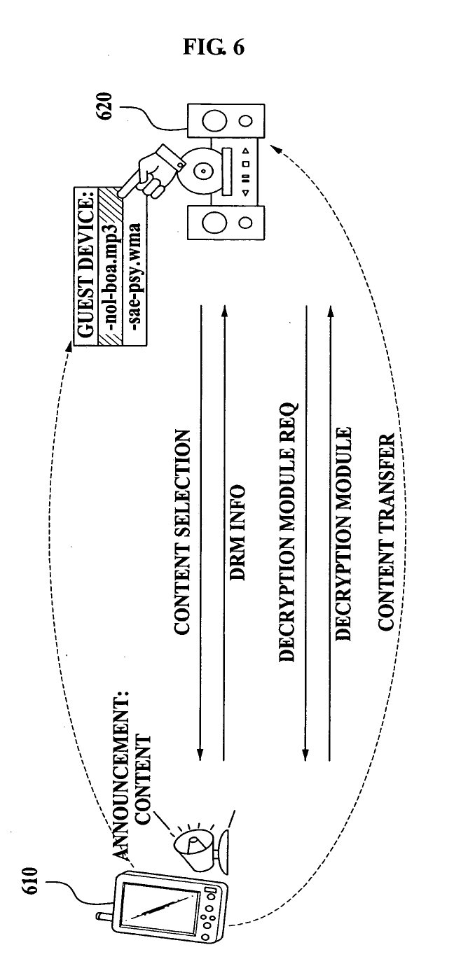

FIG. 6 is a diagram illustrating operations of ad hoc network devices sharing music content according to an exemplary embodiment of the present invention.

Referring to FIG. 6, a PDA 610 and an audio system 620 share music content via an ad hoc network. An example of a process of sharing music content between the PDA 610 and the audio system 620 illustrated in FIG. 6 will be described in detail.

Initially, the PDA 610 and the audio system 620 perform an ad hoc network configuration. In an exemplary implementation, the ad hoc network configuration may comprise all operations required for initialization of a device which wants to communicate via an ad hoc network, such as an IP setup.

A user of the audio system 620 then executes a content rendering player. In this instance, the content rendering player may be a media player from Microsoft Corporation.

When the content rendering player is executed in the audio system 620, a list of contents which may be provided from the PDA 610 is displayed on the content rendering player. For this, the PDA 610 announces information on contents maintained in the PDA, to other nodes in an ad hoc network.

In an example illustrated in FIG. 6, “nol-boa.mp3” and “sae-psy.wma” are displayed on the audio system 620 as a list of contents which may be provided from the PDA 610.

When the user of the audio system 620 selects “nol-boa.mp3”, the audio system 620 requests the PDA 610 to transmit the content of “nol-boa.mp3”. In response to the request, the PDA 610 provides DRM information on “nol-boa.mp3” to the audio system 620.

The audio system 620 interprets the provided DRM information and determines whether to download a DRM module necessary for playing “nol-boa.mp3”, from the PDA 610. In an example illustrated in FIG. 6, the audio system 620 requires a decryption module to play “nol-boa.mp3.” Accordingly, the audio system 620 requests the PDA 610 for a decryption module corresponding to “nol-boa.mp3.” The PDA 610 provides the requested decryption module to the audio system 620.

When the decryption module is received, the audio system 620 binds a DRM module to “nol-boa.mp3” by using the decryption module. Also, the audio system 620 receives the content of “nol-boa.mp3” from the PDA 610 and plays the received “nol-boa.mp3” by binding a DRM module thereto, such as decryption.

Operations of ad hoc network devices sharing music content according to an exemplary embodiment of the present invention have been described with reference to FIG. 6. According to an exemplary embodiment of the present invention, the PDA 610 may initially determine whether requested “nol-boa.mp3” is distributable. When the requested “nol-boa.mp3” is distributable, the PDA 610 updates a right object, before transmitting DRM information corresponding to “nol-boa.mp3” to the audio system 620. When transmitting DRM information, the PDA 610 may also transmit parser information corresponding to DRM information. The audio system 620 may determine whether downloading of a parser module required for parsing DRM information is necessary using the parser information. The audio system 620 may download the parser module, as necessary, from the PDA 610 and generate a corresponding parser, and parse the DRM information by using the generated parser.

A method of providing DRM interoperability and an ad hoc network device according to exemplary embodiments of the present invention can receive a DRM module from a peer in an ad hoc network and effectively share contents with different applied DRM technologies .

According to exemplary embodiments of the present invention, a method of providing DRM interoperability and an ad hoc network device facilitate the sharing of content within the limit of the content's right, even when a connection from a service provider is disconnected.

A method of providing DRM interoperability and an ad hoc network device according to exemplary embodiments of the present invention facilitate sharing of contents with new applied DRM technologies by existing devices, and facilitate a forward compatibility.

According to an exemplary embodiment of the present invention, a network device automatically downloads a DRM module from a content source and applies the downloaded DRM to a corresponding content, thereby reducing a need for user manipulation and improving user convenience.

Also, a method of providing DRM interoperability and an ad hoc network device according to exemplary embodiments of the present invention facilitate DRM interoperability in the case of a change, such as updating of a DRM technology applied to a content.

Further, a method of providing DRM interoperability and an ad hoc network device according to exemplary embodiments of the present invention facilitate DRM interoperability in, for example, a different type of platform.

Also, a method of providing DRM interoperability and an ad hoc network device according to exemplary embodiments of the present invention are suitable for interoperability in an ad hoc network using a DRM technology of a plug-in method.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of providing digital rights management (DRM) interoperability, the method comprising:
requesting a receivable content in an ad hoc network;
providing DRM information corresponding to the requested receivable content;
determining whether downloading of a DRM module is necessary using the DRM information; and
downloading the DRM module, if necessary, to bind the DRM module to the requested receivable content.

2. The method of claim 1, wherein the DRM module is downloaded from a source device to a sink device as a mobile code.

3. The method of claim 1, further comprising:
providing parser information on the DRM information;
determining whether downloading of a parser module for parsing the DRM information is necessary using the parser information; and
downloading the parser module, if necessary.

4. The method of claim 3, wherein the parser module is downloaded from a source device to a sink device as a mobile code, and the sink device executes the parser module to generate a parser and interprets the DRM information by using the parser.

5. The method of claim 3, wherein the DRM information comprises Extensible Markup Language (XML) and the parser module comprises at least one of a schema and a documentary type definition (DTD).

6. The method of claim 1, further comprising:
checking whether the requested receivable content comprises distributable content; and
updating a right with respect to the content, when the requested receivable content comprises distributable,
wherein the DRM information is provided when the requested receivable content comprises distributable.

7. The method of claim 1, further comprising:
recognizing the receivable content through a discovery process between a source device and a sink device; and
the sink device playing the requested receivable content after binding the DRM module to the receivable content.

8. The method of claim 1, wherein the DRM module comprises at least one of a decryption module, an authentication module, a network protocol module, a license management module, and a binding module.

9. An ad hoc network device comprising:
a DRM controller management unit for receiving DRM information corresponding to a receivable content from a first device in an ad hoc network, and determining whether downloading of a DRM module is necessary by using the DRM information;
a DRM module transmitting/receiving unit for downloading, as necessary, the DRM module from the first device; and
a DRM controller for binding the DRM module to the receivable content.

10. The ad hoc network device of claim 9, further comprising
a right management unit for checking and managing a right of a transferable content, in response to a request for transmission of the transferable content,
wherein the DRM module transmitting/receiving unit transmits the DRM module corresponding to the transferable content, to a second device requesting the transmission of the transferable content.

11. The ad hoc network device of claim 9, wherein the DRM module transmitting/receiving unit transmits/receives the DRM module as a mobile code.

12. The ad hoc network device of claim 9, wherein:
the DRM controller management unit receives parser information on the DRM information from the first device, and determines whether downloading of a parser module necessary for parsing the DRM information is necessary by using the parser information, and
the ad hoc network device further comprises
a parser module transmitting/receiving unit for downloading the parser module as necessary, from the first device.

13. The ad hoc network device of claim 12, wherein the DRM controller management unit executes the downloaded parser module, parses the DRM information using the parser and determines whether downloading of the DRM module is necessary.

14. The ad hoc network device of claim 13, wherein the parser module transmitting/receiving unit downloads the parser module as a mobile code.

15. The ad hoc network device of claim 12, wherein the DRM information comprises XML and the parser module comprises at least one of a schema and a DTD.

16. The ad hoc network device of claim 10, wherein the right management unit checks whether the transferable content comprises distributable content, updates right information of the transferable content and controls the DRM module transmitting/receiving unit to transmit the DRM module.

17. The device of claim 9, wherein the DRM module comprises at least one of a decryption module, an authentication module, a network protocol module, a license management module, and a binding module.

18. The method of claim 1, wherein the requesting comprises a sink device requesting a source device to transmit the receivable content in the ad hoc network.

19. The method of claim 18, wherein the providing comprises the source device providing the DRM information.

20. The method of claim 19, wherein the determining comprises the sink device determining whether the downloading of the DRM module is necessary.

21. The method of claim 20, further comprising:
the source device providing parser information on the DRM information;
the sink device determining whether downloading of a parser module for parsing the DRM information is necessary using the parser information; and
downloading the parser module, if necessary.
